(19) United States
(12) Patent Application Publication
(10) Pub. No.: US 2025/0315731 A1
(43) Pub. Date: Oct. 9, 2025

(54) MODEL COMPATIBILITY FOR LARGE LANGUAGE MODELS

(71) Applicant: Apple Inc., Cupertino, CA (US)

(72) Inventors: Mohammad Hadi POUR ANSARI, Sunnyvale, CA (US); Ting-Yao HU, Allison Park, PA (US); Jessica M. ECHTERHOFF, La Jolla, CA (US); Fartash FAGHRI, Seattle, WA (US); Cuneyt O. TUZEL, Cupertino, CA (US); Chun-Liang LI, Seattle, WA (US); Raviteja VEMULAPALLI, Mill Creek, WA (US)

(21) Appl. No.: 19/098,961

(22) Filed: Apr. 2, 2025

Related U.S. Application Data
(60) Provisional application No. 63/574,831, filed on Apr. 4, 2024.

(51) Int. Cl. G06N 20/00

(52) U.S. Cl. CPC G06N 20/00

(57) ABSTRACT

The subject technology relates to model compatibility for large language models. An apparatus receives a first trained machine learning model having a first adapter layer and generates a second trained machine learning model having a second adapter layer, in which the second model is a transformed version of the first model and both models share a base model. The apparatus initializes the second adapter layer using parameters derived from the first adapter layer and trains the second adapter layer using parameters of the first adapter layer and initialization parameters of the second adapter layer. The apparatus computes a divergence metric between probability distributions of the two models to assess a difference between them. The second adapter layer may be adjusted based on the divergence metric exceeding a threshold. The apparatus deploys the second trained machine learning model in a computing environment based on the divergence metric not exceeding the threshold.

### CROSS REFERENCE TO RELATED APPLICATION(S)

The present application claims the benefit of U.S. Provisional Application No. 63/574,831, entitled “MODEL COMPATIBILITY FOR LARGE LANGUAGE MODELS”, filed Apr. 4, 2024, the entirety of which is incorporated herein for reference.

### TECHNICAL FIELD

The present description generally relates to model compatibility for large language models.

### BACKGROUND

Machine learning has seen a significant rise in popularity in recent years due to the availability of training data, and advances in more powerful and efficient computing hardware. Machine learning may utilize models that are executed to provide predictions in particular applications. Large language models are characterized by their substantial size, often comprising hundreds of millions to billions of parameters. These models require significant computational power and memory for training and inference. The vast number of parameters allows them to capture complex linguistic patterns and generate coherent and contextually relevant text, making them powerful tools in natural language processing tasks. However, a change in these large language models also presents challenges related to model performance and compatibility with previous model versions.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment in accordance with one or more implementations.

FIG. 2 illustrates an example computing architecture for a system providing machine learning models, in accordance with one or more implementations.

FIG. 3 conceptually illustrates an example overview of a large language model version update in accordance with one or more implementations.

FIG. 4 is a flow chart of an example process that may be performed for model compatibility for large language models in accordance with one or more implementations.

FIG. 5 conceptually illustrates an example of a compatibility adapter for a large language model version update in accordance with one or more implementations.

FIG. 6 conceptually illustrates an example overview of evaluation metrics for evaluating tasks performed between different large language model versions in accordance with one or more implementations.

FIG. 7 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Advancements in artificial intelligence (AI) have led to the deployment of end-user-interfacing systems, which are frequently updated due to changes in data or architecture. Conversational assistants leverage downstream large language models (LLMs) for various tasks, with updates driven by user interactions and data accumulation. As new tasks emerge, systems evolve to accommodate them, such as supporting translation and math queries. The decreasing cost per unit of computation facilitates training of larger models, while new architectures contribute to enhanced LLM performance, prompting ongoing updates and improvements in the field. A base LLM can be deployed to support various downstream tasks such as summarization, classification and chat assistance via a task-specific adapter module. The architecture of the LLM may be updated to incorporate new components, layers, or techniques that improve performance, efficiency, or robustness. For example, the new version may include enhancements such as additional attention mechanisms, layer normalization, or novel activation functions. When upgrading the base LLM from an old version to a new version, the task-specific adapter modules for the downstream tasks necessitate retraining. These changes, however, can introduce regression or inconsistent behavior in the downstream tasks between LLM versions.

Embodiments of the subject technology provide for a compatibility adapter module to be used alongside a downstream task adapter module in LLM, facilitating consistent model behavior between LLM versions. An apparatus receives a first trained machine learning model having a first adapter layer and generates a second trained machine learning model having a second adapter layer, in which the second trained machine learning model is a transformed version of the first trained machine learning model and both models include a common base model. The apparatus initializes the second adapter layer using parameters derived from the first adapter layer and trains the second adapter layer using one or more parameters of the first adapter layer and one or more initialization parameters of the second adapter layer. The apparatus evaluates the second trained machine learning model by computing a divergence metric between probability distributions of the first trained machine learning model and the second trained machine learning model to assess a difference between the first trained machine learning model and the second trained machine learning model, in which one or more parameters of the second adapter layer are adjusted based on the divergence metric exceeding a threshold. The apparatus deploys the second trained machine learning model in a computing environment based at least in part on the divergence metric not exceeding the threshold.

Implementations of the subject technology improve the ability of a given electronic device to provide machine-learning generated data to a user (e.g., a user of the given electronic device). These benefits therefore are understood as improving the computing functionality of a given electronic device, such as an end user device which may generally have less computational and/or power resources available than, e.g., one or more cloud-based servers.

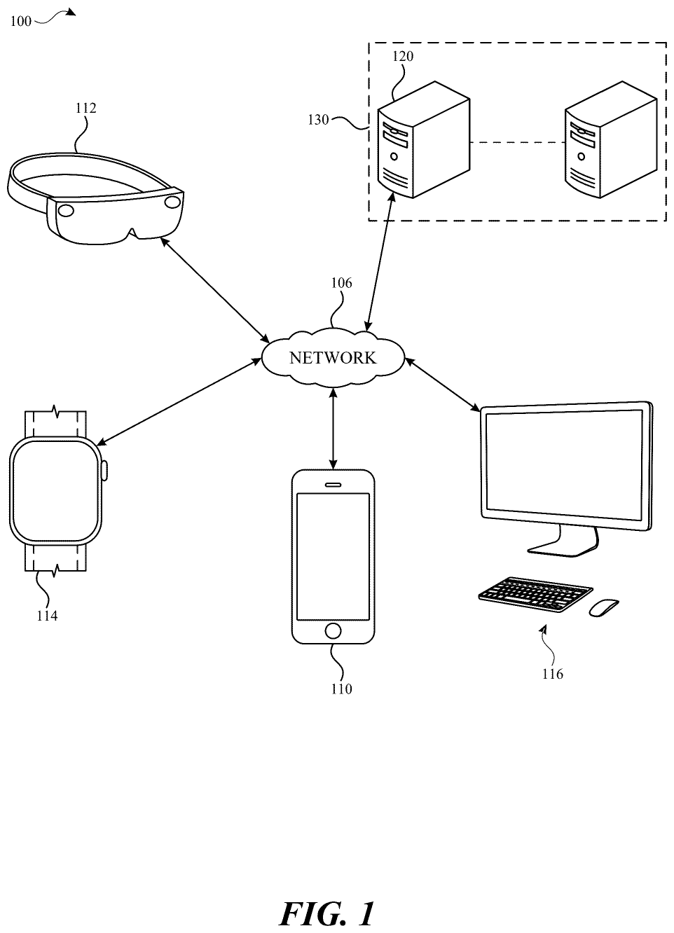

FIG. 1 illustrates an example network environment 100 in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The network environment 100 includes an electronic device 110, an electronic device 112, an electronic device 114, an electronic device 116, and a server 120. The network 106 may communicatively (directly or indirectly) couple the electronic device 110 and/or the server 120. In one or more implementations, the network 106 may be an interconnected network of devices that may include, or may be communicatively coupled to, the Internet. For explanatory purposes, the network environment 100 is illustrated in FIG. 1 as including the electronic device 110, the electronic device 112, the electronic device 114, the electronic device 116, and the server 120; however, the network environment 100 may include any number of electronic devices and any number of servers or a data center including multiple servers.

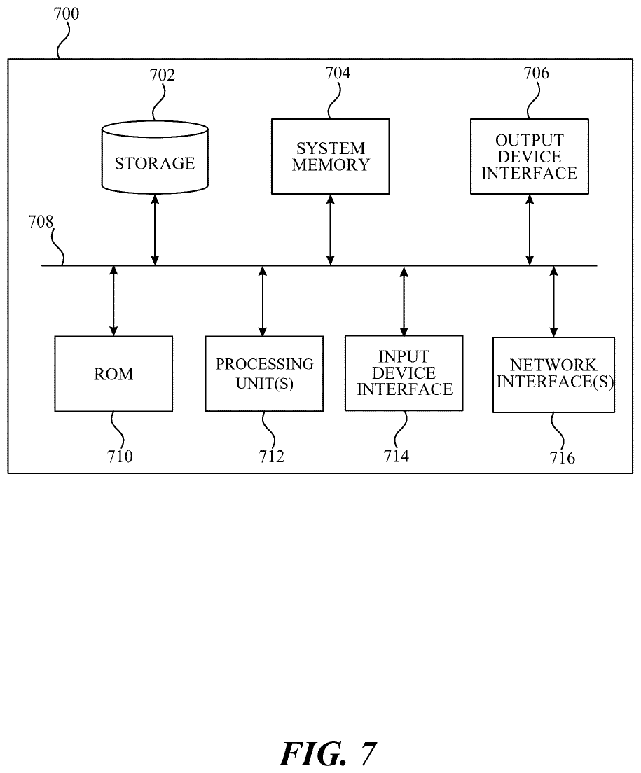

The electronic device 110 may be, for example, a desktop computer, a portable computing device such as a laptop computer, a smartphone, a peripheral device (e.g., a digital camera, headphones), a tablet device, a wearable device such as a watch, a band, and the like. In FIG. 1, by way of example, the electronic device 110 is depicted as a mobile electronic device (e.g., smartphone). The electronic device 110 may be, and/or may include all or part of, the electronic system discussed below with respect to FIG. 7.

The electronic device 112 may be, for example, desktop computer, a portable computing device such as a laptop computer, a smartphone, a peripheral device (e.g., a digital camera, headphones), a tablet device, or a wearable device such as a head mountable portable system, that includes a display system capable of presenting a visualization of an extended reality environment to a user. In FIG. 1, by way of example, the electronic device 112 is depicted as a head mountable portable system. The electronic device 112 may be, and/or may include all or part of, the electronic system discussed below with respect to FIG. 7.

The electronic device 114 may be, for example, desktop computer, a portable computing device such as a laptop computer, a smartphone, a peripheral device (e.g., a digital camera, headphones), a tablet device, a wearable device such as a watch, a band, and the like. In FIG. 1, by way of example, the electronic device 114 is depicted as a watch. The electronic device 114 may be, and/or may include all or part of, the electronic system discussed below with respect to FIG. 7.

The electronic device 116 may be, for example, desktop computer, a portable computing device such as a laptop computer, a smartphone, a peripheral device (e.g., a digital camera, headphones), a tablet device, a wearable device such as a watch, a band, and the like. In FIG. 1, by way of example, the electronic device 116 is depicted as a desktop computer. The electronic device 116 may be, and/or may include all or part of, the electronic system discussed below with respect to FIG. 7.

In one or more implementations, one or more of the electronic devices 110-116 may provide a system for training a machine learning model using training data, where the trained machine learning model is subsequently deployed to one or more of the electronic devices 110-116. Further, one or more of the electronic devices 110-116 may provide one or more machine learning frameworks for training machine learning models and/or developing applications using such machine learning models. In an example, such machine learning frameworks can provide various machine learning algorithms and models for different problem domains in machine learning. In an example, the electronic device 110 may include a deployed machine learning model that provides an output of data corresponding to a prediction or some other type of machine learning output. In one or more implementations, training and inference operations that involve individually identifiable information of a user of one or more of the electronic devices 110-116 may be performed entirely on the electronic devices 110-116, to prevent exposure of individually identifiable data to devices and/or systems that are not authorized by the user.

The server 120 may form all or part of a network of computers or a group of servers 130, such as in a cloud computing or data center implementation. For example, the server 120 stores data and software, and includes specific hardware (e.g., processors, graphics processors and other specialized or custom processors) for rendering and generating content such as graphics, images, video, audio and multi-media files. In an implementation, the server 120 may function as a cloud storage server that stores any of the aforementioned content generated by the above-discussed devices and/or the server 120.

The server 120 may provide a system for training a machine learning model using training data, where the trained machine learning model is subsequently deployed to the server 120 and/or to one or more of the electronic devices 110-116. In an implementation, the server 120 may train a given machine learning model for deployment to a client electronic device (e.g., the electronic device 110, the electronic device 112, the electronic device 114, the electronic device 116). In one or more implementations, the server 120 may train portions of the machine learning model using (e.g., anonymized) training data from a population of users, and one or more of the electronic devices 110-116 may train portions of the machine learning model using individual training data from the user of the electronic devices 110-116. The machine learning model deployed on the server 120 and/or one or more of the electronic devices 110-116 can then perform one or more machine learning algorithms. In an implementation, the server 120 provides a cloud service that utilizes the trained machine learning model and/or continually learns over time.

In the example of FIG. 1, the electronic device 110 is depicted as a smartphone. However, it is appreciated that the electronic device 110 may be implemented as another type of device, such as a wearable device (e.g., a smart watch or other wearable device). The electronic device 110 may be a device of a user (e.g., the electronic device 110 may be associated with and/or logged into a user account for the user at a server). Although a single electronic device 110 is shown in FIG. 1, it is appreciated that the network environment 100 may include more than one electronic device, including more than one electronic device of a user and/or one or more other electronic devices of one or more other users.

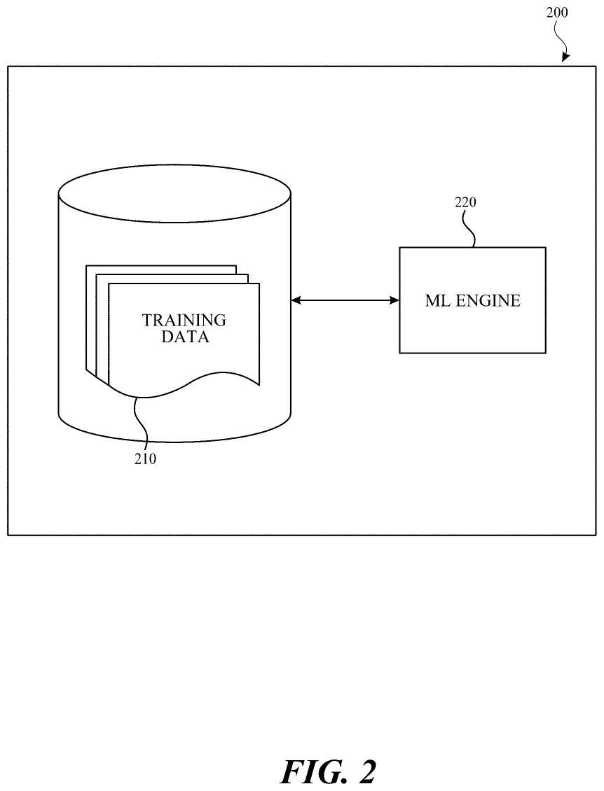

FIG. 2 illustrates an example computing architecture for a system providing machine learning models, in accordance with one or more implementations. For explanatory purposes, the computing architecture is described as being provided by an electronic device 200, such as by a processor and/or memory of the server 120, or by a processor and/or a memory of any other electronic device, such as the electronic device 110. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

As illustrated, the electronic device 200 includes training data 210 for training a machine learning model. In an example, the server 120 may utilize one or more machine learning algorithms that uses training data 210 for training a machine learning (ML) model 220. ML model 220 may include one or more neural networks. In one or more implementations, the ML model 220 is a large language model.

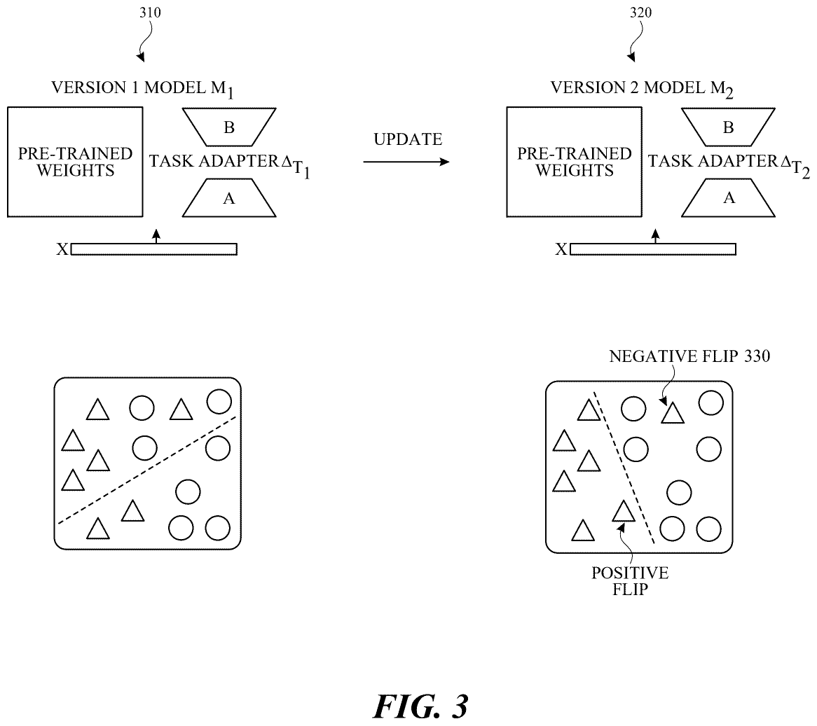

FIG. 3 conceptually illustrates an example overview of a large language model version update in accordance with one or more implementations. As illustrated in FIG. 3, a first trained machine learning model 310 (e.g., [symbol] ₁) having a first adapter layer (e.g., Δ_{T}_{₁}) is changed into a second trained machine learning model 320 (e.g., [symbol] ₂) having a second adapter layer (e.g., Δ_{T}_{₂}) that is a different version from the first trained machine learning model 310. The two versions can include a common pre-trained base model (e.g., LLM). In one or more implementations, the first adapter layer and the second adapter layer may be the same task-specific adapter for handling downstream tasks of the base LLM. In one or more other implementations, the first adapter layer and the second adapter layer are different adapters, in which the second adapter layer can be used alongside a downstream task adapter layer (e.g., the first adapter layer) to facilitate a smooth update between models. In one or more implementations, the first trained machine learning model 310 and the second trained machine learning model 320 may each be implemented as the ML model 220 as described with reference to FIG. 2.

In one or more implementations, an adapter layer (e.g., first adapter layer, second adapter layer) can be a parametrized module within the pre-trained base model to enable adaptation for new tasks or domain-specific modifications. Unlike a standard layer, the adapter layer may serve as an intermediate layer that can be trained independently while maintaining the core parameters of the pre-trained base model. The adapter layer can be structured as a small feedforward neural network, attention mechanism or other transformation function that can modify the output of the pre-trained base model layers in a task-specific manner. In FIG. 3, the first adapter layer and the second adapter layer may enable modifications to the trained machine learning model 310 and the trained machine learning model 320 respectively while maintaining the pre-trained base model. The first and second adapter layers can facilitate versioning and task-specific customization without requiring retraining of the pre-trained base model, allowing for more efficient updates and deployment of machine learning models.

Changes in architecture, data, hyperparameters, or instruction finetuning may be implemented to improve performance or computational efficiency in a model. However, such alterations can introduce negative flips or inconsistent behavior, impacting the user's expectations of the model's behavior. The importance of compatible model updates lies in facilitating consistency and minimizing discrepancies between different versions of the model. It is desirable to achieve close alignment between versions to maintain correctness and prevent inconsistencies for users. While the primary goal of model updates is performance improvement, facilitating similarity between versions is desirable even when performance gains may not be achievable.

In the context of single-choice classification tasks, autoregressive training on commonsense question answering benchmarks such as BoolQ and PiQA, along with math questions evaluated using exact match metrics such as GSM8K, can be employed on the task-specific adapter layer. Despite training the task-specific adapter layer on the same data for both versions (Δ_{T}_{₁} and Δ_{T}_{₂}) and changing the pre-trained base model (e.g., base LLM), negative flips (e.g., negative flip 330) can be observed during evaluation, impacting the likelihood of answer options and exact match performance. In the domain of multiple-choice classification, instances of negative flips from one incorrect class to another can be observed during evaluation. Such occurrences have the potential to disrupt human mental models and established procedures for handling incorrect model behavior.

In classification tasks, coarse classification metrics may not provide sufficient granularity to measure the degree of improvement towards the correct answer. For generation tasks, the concept of negative flips (e.g., 330) is ambiguous due to the lack of clear evaluation metrics. There is a need for metrics that capture the improvement over a previous model and the similarity to the previous model, enabling a better understanding of model performance and facilitating comparisons between different versions. The system may compute a divergence metric between probability distributions of the first trained machine learning model and the second trained machine learning model to assess a difference between the first trained machine learning model and the second trained machine learning model. In one or more implementations, one or more parameters of the second trained machine learning model may be adjusted based on the divergence metric exceeding a threshold to facilitate consistent behavior between the models.

In one or more implementations, for single and multiple-choice classification tasks, a first divergence metric can be employed as a measure to quantify the similarity between two probability distributions. For example, the first divergence metric can refer to the Jensen-Shannon Divergence. In one or more other implementations, for comparing probability distributions over options and ground truth, a second divergence metric can be employed as a measure of how one probability distribution differs from a second, reference probability distribution. For example, the second divergence metric can refer to the Kullback-Leibler (KL) Divergence, which can quantify the difference between the predicted distribution (e.g., model probabilities) and the ground truth distribution (e.g., true labels or target probabilities) in classification tasks. In one or more other implementations, model update gain and model update similarity metrics can be employed, with gain computed as the difference in similarity scores between the new and previous versions regarding a reference answer, and similarity quantified by the first divergence metric between probability distributions. In one or more implementations, the model update gain metric is computed as a difference in similarity scores between the first trained machine learning model and the second trained machine learning model with respect to a reference answer. In one or more other implementations, the model update similarity metric is computed using a first divergence metric between the probability distributions of the first trained machine learning model and the second trained machine learning model.

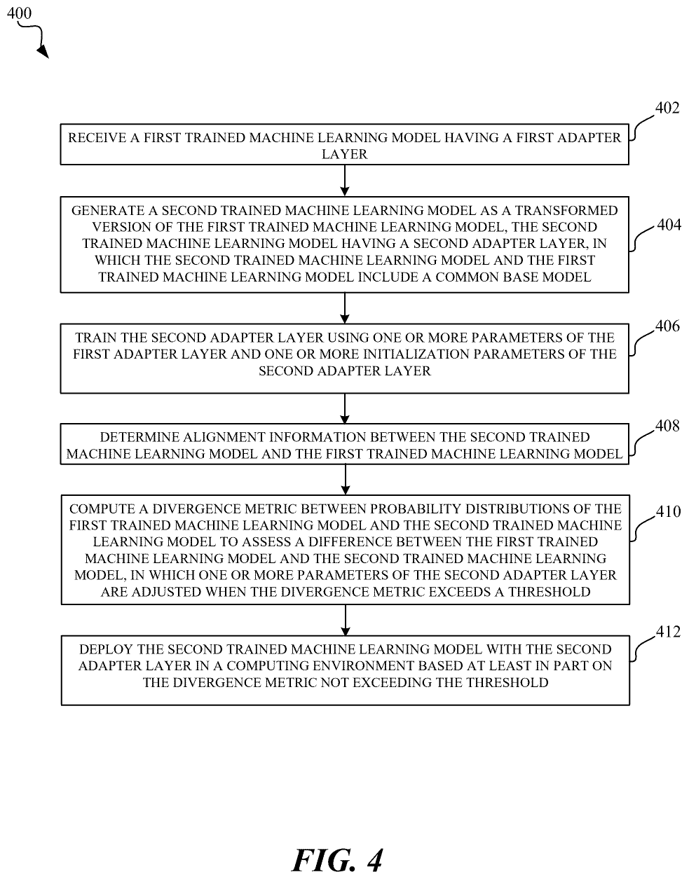

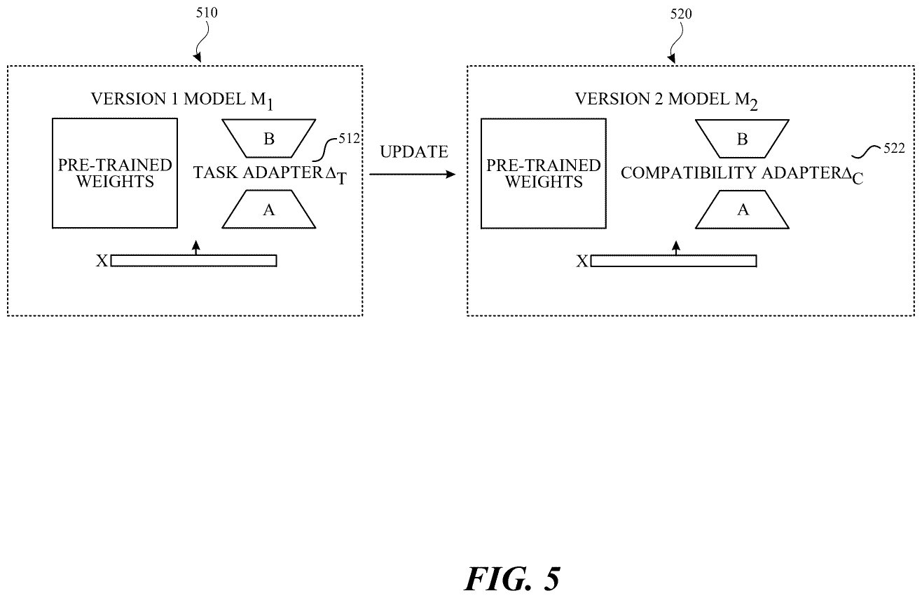

FIG. 4 is a flow chart of an example process that may be performed for model compatibility for large language models in accordance with one or more implementations. For explanatory purposes, the process 400 is primarily described herein with reference to the electronic device 110 of FIG. 1. However, the process 400 is not limited to the electronic device 110 of FIG. 1, and one or more blocks (or operations) of the process 400 may be performed by one or more other components of other suitable devices and/or servers. Further for explanatory purposes, some of the blocks of the process 400 are described herein as occurring in serial, or linearly. However, multiple blocks of the process 400 may occur in parallel. In addition, the blocks of the process 400 need not be performed in the order shown and/or one or more blocks of the process 400 need not be performed and/or can be replaced by other operations. For purposes of brevity in explanation, aspects of the process 400 will be discussed with reference to FIG. 5. FIG. 5 conceptually illustrates an example of a compatibility adapter for a large language model version update in accordance with one or more implementations.

As illustrated in FIG. 4, at block 402, an apparatus (e.g., electronic device 110, 112, 114, 116; ML model 220; processing unit(s) 712) can receive a first trained machine learning model 510 having a first adapter layer 512.

At block 404, the apparatus can generate a second trained machine learning model 520 having a second adapter layer 522. In one or more implementations, the second trained machine learning model 520 is a transformed version of the first trained machine learning model 510. For example, the first trained machine learning model 510 is a version 1 model ( [symbol] ₁) and the second trained machine learning model 520 is a version 2 model ( [symbol] ₂).

At block 406, the apparatus can initialize the second adapter layer 522 using parameters derived from the first adapter layer 512.

At block 408, the apparatus can train the second adapter layer 522 using one or more parameters of the first adapter layer 512 and one or more initialization parameters of the second adapter layer 522.

At block 410, the apparatus can determine alignment information between the second trained machine learning model 520 and the first trained machine learning model 510, facilitating consistent model behavior between LLM versions. In one or more implementations, in determining the alignment information, the apparatus can compute a divergence metric between probability distributions of the first trained machine learning model and the second trained machine learning model to assess a difference between the first trained machine learning model and the second trained machine learning model. In some aspects, one or more parameters of the second adapter layer can be adjusted when the divergence metric exceeds a threshold.

In one or more implementations, in determining the alignment information, the apparatus can align logits of the first trained machine learning model 510 with logits of the second trained machine learning model 520 using Kullback-Leibler divergence, which can be defined as follows:

$${D}_{K L} ( P ‖ Q ) = {\sum }_{x ∈ X} P ( x ) log ( \frac{P ( x )}{Q ( x )} ) . \qquad ( 1 )$$

In one or more implementations, the apparatus can produce an interpolated output by interpolating between the second adapter layer 522 and the first adapter layer 512 using the alignment information. In some aspects, the second adapter layer 522 may be based on at least a portion of the interpolated output, which can be defined as follows:

$$Δ = α {Δ}_{C} + ( 1 - α ) {Δ}_{T} . \qquad ( 2 )$$

At block 414, the apparatus can deploy the second trained machine learning model 520 with the second adapter layer 522 in a computing environment based at least in part on the divergence metric not exceeding the threshold.

In one or more other implementations, the apparatus can determine one or more evaluation metrics indicating one or more of a level of improvement from the first trained machine learning model to the second trained machine learning model or a level of similarity between the second trained machine learning model and the first trained machine learning model. For example, in computing the divergence metric, the apparatus can determine an evaluation metric indicating a negative flip probability and a positive flip probability between the second trained machine learning model and the first trained machine learning model. In another example, in computing the divergence metric, the apparatus can determine an evaluation metric indicating a negative compatibility probability and a positive compatibility probability between the second trained machine learning model and the first trained machine learning model. In another example, in computing the divergence metric, the apparatus can determine an evaluation metric indicating an expected regression and an expected gain between the second trained machine learning model and the first trained machine learning model. In another example, in computing the divergence metric, the apparatus can determine an evaluation metric indicating an expected compatibility between the second trained machine learning model and the first trained machine learning model.

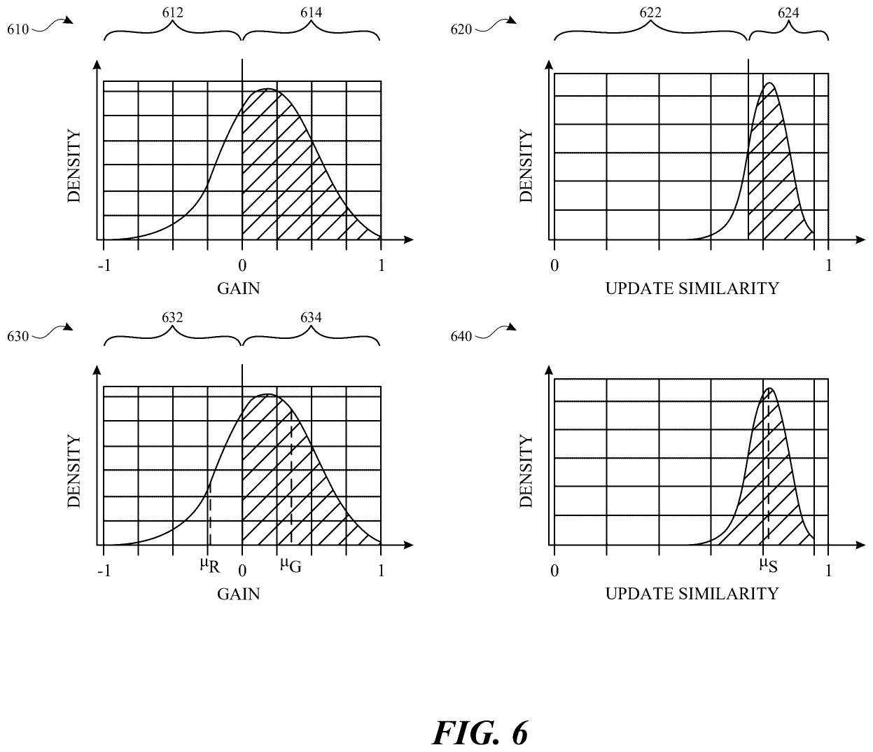

FIG. 6 conceptually illustrates an example overview of evaluation metrics for evaluating tasks performed between different large language model versions in accordance with one or more implementations. In plot 610, a signal waveform bounded between gain and density can be used to quantify the likelihood of negative and positive flips between model versions. A first portion 612 of the signal waveform in a range of −1 to 0 gain can indicate the Negative Flip Probability (NFP) while a second portion 614 of the signal waveform in a range of 0 to 1 gain can indicate the Positive Flip Probability (PFP). The NFP and PFP can be defined as follows:

$$N F P = {\int }_{- 1}^{0} f ( x ) dx . \qquad ( 3 )$$

$$PFP = {\int }_{0}^{1} f ( x ) dx . \qquad ( 4 )$$

In plot 620, a signal waveform bounded between update similarity and density can be used to quantify the probability of negative and positive compatibility between model versions. A first portion 622 of the signal waveform in a range of 0 to x update similarity can indicate the Negative Compatibility Probability (NCP) while a second portion 624 of the signal waveform in a range of x to 1 update similarity can indicate the Positive Compatibility Probability (PCP). The NFP and PFP can be defined as follows:

$$N C P = {\int }_{0}^{t} f ( x ) dx . \qquad ( 5 )$$

$$PCP = {\int }_{t}^{1} f ( x ) dx . \qquad ( 6 )$$

In plot 630, a signal waveform bounded between gain and density can be used to quantify the expected regression and expected gain between model versions. A first portion 632 of the signal waveform in a range of −1 to 0 gain can indicate the expected regression (UR) while a second portion 634 of the signal waveform in a range of 0 to 1 gain can indicate the expected gain (UG). The expected regression and expected gain can be defined as follows:

$${μ}_{R} = {\int }_{- 1}^{0} \vert x \vert f ( x ) dx . \qquad ( 7 )$$

$${μ}_{G} = {\int }_{0}^{1} \vert x \vert f ( x ) dx . \qquad ( 8 )$$

In plot 640, a signal waveform bounded between update similarity and density can be used to quantify the expected compatibility (μₛ) between versions. These aforementioned evaluation metrics collectively contribute to a comprehensive understanding of the behavior of the model updates, facilitating effective decision-making and evaluation processes. The expected compatibility can be defined as follows:

$${μ}_{S} = {\int }_{0}^{1} \vert x \vert f ( x ) dx . \qquad ( 9 )$$

FIG. 7 illustrates an electronic system 700 with which one or more implementations of the subject technology may be implemented. The electronic system 700 can be, and/or can be a part of, the electronic device 110, and/or the server 120 shown in FIG. 1. The electronic system 700 may include various types of computer readable media and interfaces for various other types of computer readable media. The electronic system 700 includes a bus 708, one or more processing unit(s) 712, a system memory 704 (and/or buffer), a ROM 710, a permanent storage device 702, an input device interface 714, an output device interface 706, and one or more network interfaces 716, or subsets and variations thereof.

The bus 708 collectively represents all system, peripheral, and chipset buses that communicatively connect the numerous internal devices of the electronic system 700. In one or more implementations, the bus 708 communicatively connects the one or more processing unit(s) 712 with the ROM 710, the system memory 704, and the permanent storage device 702. From these various memory units, the one or more processing unit(s) 712 retrieves instructions to execute and data to process in order to execute the processes of the subject disclosure. The one or more processing unit(s) 712 can be a single processor or a multi-core processor in different implementations.

The ROM 710 stores static data and instructions that are needed by the one or more processing unit(s) 712 and other modules of the electronic system 700. The permanent storage device 702, on the other hand, may be a read-and-write memory device. The permanent storage device 702 may be a non-volatile memory unit that stores instructions and data even when the electronic system 700 is off. In one or more implementations, a mass-storage device (such as a magnetic or optical disk and its corresponding disk drive) may be used as the permanent storage device 702.

In one or more implementations, a removable storage device (such as a flash drive, and its corresponding solid state drive) may be used as the permanent storage device 702. Like the permanent storage device 702, the system memory 704 may be a read-and-write memory device. However, unlike the permanent storage device 702, the system memory 704 may be a volatile read-and-write memory, such as random access memory. The system memory 704 may store any of the instructions and data that one or more processing unit(s) 712 may need at runtime. In one or more implementations, the processes of the subject disclosure are stored in the system memory 704, the permanent storage device 702, and/or the ROM 710. From these various memory units, the one or more processing unit(s) 712 retrieves instructions to execute and data to process in order to execute the processes of one or more implementations.

The bus 708 also connects to the input device interface 714 and output device interface 706. The input device interface 714 enables a user to communicate information and select commands to the electronic system 700. Input devices that may be used with the input device interface 714 may include, for example, alphanumeric keyboards and pointing devices (also called “cursor control devices”). The output device interface 706 may enable, for example, the display of images generated by electronic system 700. Output devices that may be used with the output device interface 706 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 7, the bus 708 also couples the electronic system 700 to one or more networks and/or to one or more network nodes, such as the electronic device 110 shown in FIG. 1, through the one or more network interface(s) 716. In this manner, the electronic system 700 can be a part of a network of computers (such as a LAN, a wide area network (“WAN”), or an Intranet, or a network of networks, such as the Internet. Any or all components of the electronic system 700 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method, comprising:
receiving a first trained machine learning model comprising a first adapter layer;
generating a second trained machine learning model as a transformed version of the first trained machine learning model, the second trained machine learning model comprising a second adapter layer, wherein the second trained machine learning model and the first trained machine learning model comprise a common base model;
initializing the second adapter layer using parameters derived from the first adapter layer;
training the second adapter layer using one or more of the parameters of the first adapter layer and one or more initialization parameters of the second adapter layer;
computing a divergence metric between probability distributions of the first trained machine learning model and the second trained machine learning model to assess a difference between the first trained machine learning model and the second trained machine learning model, wherein one or more parameters of the second adapter layer are adjusted when the divergence metric exceeds a threshold; and
deploying the second trained machine learning model with the second adapter layer in a computing environment based at least in part on the divergence metric not exceeding the threshold.

2. The method of claim 1, wherein generating the second trained machine learning model comprises modifying a first set of parameters associated with the first trained machine learning model while maintaining a second set of parameters associated with the common base model, and wherein the second trained machine learning model comprises the modified first set of parameters and the second set of parameters.

3. The method of claim 1, wherein computing the divergence metric comprises computing a first divergence metric using Jensen-Shannon divergence to measure similarity between a probability distribution of the first trained machine learning model and a probability distribution of the second trained machine learning model.

4. The method of claim 3, wherein the first divergence metric is used to determine alignment between the probability distribution of the second trained machine learning model and a reference probability distribution associated with ground truth labels.

5. The method of claim 1, wherein computing the divergence metric comprises computing a second divergence metric using Kullback-Leibler (KL) divergence to quantify a difference between a probability distribution of the second trained machine learning model and a reference probability distribution associated with ground truth labels.

6. The method of claim 1, wherein computing the divergence metric comprises computing a model update gain metric and a model update similarity metric, wherein:
the model update gain metric is computed as a difference in similarity scores between the first trained machine learning model and the second trained machine learning model with respect to a reference answer, and
the model update similarity metric is computed using a first divergence metric between the probability distributions of the first trained machine learning model and the second trained machine learning model.

7. The method of claim 1, wherein computing the divergence metric comprises determining one or more evaluation metrics indicating one or more of a level of improvement from the first trained machine learning model to the second trained machine learning model or a level of similarity between the second trained machine learning model and the first trained machine learning model.

8. The method of claim 1, wherein computing the divergence metric comprises determining an evaluation metric indicating a negative flip probability and a positive flip probability between the second trained machine learning model and the first trained machine learning model.

9. The method of claim 1, wherein computing the divergence metric comprises determining an evaluation metric indicating a negative compatibility probability and a positive compatibility probability between the second trained machine learning model and the first trained machine learning model.

10. The method of claim 1, wherein computing the divergence metric comprises determining an evaluation metric indicating an expected regression and an expected gain between the second trained machine learning model and the first trained machine learning model.

11. The method of claim 1, wherein computing the divergence metric comprises determining an evaluation metric indicating an expected compatibility between the second trained machine learning model and the first trained machine learning model.

12. A non-transitory machine-readable medium comprising code that, when executed by a processor, causes the processor to perform operations comprising:
receiving a first trained machine learning model comprising a first adapter layer;
generating a second trained machine learning model as a transformed version of the first trained machine learning model, the second trained machine learning model comprising a second adapter layer, wherein the second trained machine learning model and the first trained machine learning model comprise a common base model;
initializing the second adapter layer using parameters derived from the first adapter layer;
training the second adapter layer using one or more of the parameters of the first adapter layer and one or more initialization parameters of the second adapter layer;
computing a divergence metric between probability distributions of the first trained machine learning model and the second trained machine learning model to assess a difference between the first trained machine learning model and the second trained machine learning model, wherein one or more parameters of the second adapter layer are adjusted based on the divergence metric exceeding a threshold; and
deploying the second trained machine learning model in a computing environment based at least in part on the divergence metric not exceeding the threshold.

13. The non-transitory machine-readable medium of claim 12, wherein generating the second trained machine learning model comprises modifying a first set of parameters associated with the first trained machine learning model while maintaining a second set of parameters associated with the common base model, and wherein the second trained machine learning model comprises the modified first set of parameters and the second set of parameters.

14. The non-transitory machine-readable medium of claim 12, wherein evaluating the second trained machine learning model comprises computing a first divergence metric using Jensen-Shannon divergence to measure similarity between a probability distribution of the first trained machine learning model and a probability distribution of the second trained machine learning model.

15. The non-transitory machine-readable medium of claim 14, wherein the first divergence metric is used to determine alignment between the probability distribution of the second trained machine learning model and a reference probability distribution associated with ground truth labels.

16. The non-transitory machine-readable medium of claim 12, wherein evaluating the second trained machine learning model comprises computing a second divergence metric using Kullback-Leibler (KL) divergence to quantify a difference between a probability distribution of the second trained machine learning model and a reference probability distribution associated with ground truth labels.

17. The non-transitory machine-readable medium of claim 12, wherein evaluating the second trained machine learning model further comprises computing a model update gain metric and a model update similarity metric, wherein:
the model update gain metric is computed as a difference in similarity scores between the first trained machine learning model and the second trained machine learning model with respect to a reference answer, and
the model update similarity metric is computed using a first divergence metric between the probability distributions of the first trained machine learning model and the second trained machine learning model.

18. A device, comprising:
a memory; and
one or more processors configured to:
receive a first trained machine learning model comprising a first adapter layer;
generate a second trained machine learning model as a transformed version of the first trained machine learning model, the second trained machine learning model comprising a second adapter layer, wherein the second trained machine learning model and the first trained machine learning model comprise a common base model;
initialize the second adapter layer using parameters derived from the first adapter layer;
train the second adapter layer using one or more of the parameters of the first adapter layer and one or more initialization parameters of the second adapter layer;
compute a divergence metric between probability distributions of the first trained machine learning model and the second trained machine learning model to assess a difference between the first trained machine learning model and the second trained machine learning model, wherein one or more parameters of the second adapter layer are adjusted based on the divergence metric exceeding a threshold; and
deploy the second trained machine learning model in a computing environment based at least in part on the divergence metric not exceeding the threshold.

19. The device of claim 18, wherein the one or more processors configured to generate the second trained machine learning model are further configured to modify a first set of parameters associated with the first trained machine learning model while maintaining a second set of parameters associated with the common base model.

20. The device of claim 18, wherein the one or more processors configured to compute the divergence metric are further configured to compute a first divergence metric using Jensen-Shannon divergence to measure similarity between a probability distribution of the first trained machine learning model and a probability distribution of the second trained machine learning model, and wherein the first divergence metric is used to determine alignment between the probability distribution of the second trained machine learning model and a reference probability distribution associated with ground truth labels.
